(19) United States
(12) Patent Application Publication
(10) Pub. No.: US 2018/0166917 A1
(43) Pub. Date: Jun. 14, 2018

(54) WIRELESS CHARGING SYSTEM OF UNMANNED AERIAL VEHICLE AND UNMANNED AERIAL VEHICLE

(71) Applicant: HON HAI PRECISION INDUSTRY CO., LTD., New Taipei (TW)

(72) Inventor: I-THUN LIN, New Taipei (TW)

(21) Appl. No.: 15/690,412

(22) Filed: Aug. 30, 2017

(30) Foreign Application Priority Data
Dec. 14, 2016 (TW) 105141300

(51) Int. Cl. H02J 50/10; B64C 39/02; H02J 7/02

(52) U.S. Cl. CPC H02J 50/10; B64C 2201/066; H02J 7/025; B64C 39/024

(57) ABSTRACT

A wireless charging system of an unmanned aerial vehicle includes a transmitting module including an external power supply and a transmitting induction coil electrically connected to the external power supply. The transmitting induction coil is used to generates an induced magnetic field. The wireless charging system further includes a receiving module including a receiving induction coil and a battery. The receiving induction coil is located in a landing gear of the unmanned aerial vehicle and electrically connected to the battery. The receiving induction coil is used to generate a induced current that is charged back to the battery.

### CROSS-REFERENCE TO RELATED APPLICATIONS

This application claims all benefits accruing under 35 U.S.C. § 119 from Taiwan Patent Application No. 105141300, filed on Dec. 14, 2016, in the Taiwan Intellectual Property Office. This application is related to commonly-assigned and concurrently filed US patent applications entitled, “WIRELESS CHARGING SYSTEM OF UNMANNED AERIAL VEHICLE AND UNMANNED AERIAL VEHICLE” (Atty. Docket No. US60458) and “WIRELESS CHARGING SYSTEM OF UNMANNED AERIAL VEHICLE AND UNMANNED AERIAL VEHICLE” (Atty. Docket No. US61094). Disclosures of all the above-identified applications are incorporated herein by reference.

### FIELD

The present application relates to a wireless charging system of unmanned aerial vehicle (UAV) and an unmanned aerial vehicle including the wireless charging system.

### BACKGROUND

An UAV, commonly known as a drone, is an aircraft without a human pilot aboard. For UAV, a critical indicator is the flight time. The electric quantity of a battery that is installed on the UAV affect the flight time. The electric quantity of the battery in the UAV is complemented by two methods: manually replacing the original battery with new battery; or manually connecting the battery plug to the charger. However, the UAV can not be automatically charged by the above two methods.

What is needed, therefore, is to provide a wireless charging system of unmanned aerial vehicle that can overcome the above-described shortcomings.

### BRIEF DESCRIPTION OF THE DRAWINGS

Implementations of the present technology will now be described, by way of example only, with reference to the attached figures, wherein:

FIG. 1 is a functional diagram of a first embodiment of a wireless charging system of an unmanned aerial vehicle.

FIG. 2 is a schematic view of the first embodiment of the unmanned aerial vehicle that is close to a parking mat.

FIG. 3 is a functional diagram of a second embodiment of a wireless charging system of an unmanned aerial vehicle.

FIG. 4 is a flow chart of a working method of a receiving module in the wireless charging system of FIG. 3.

FIG. 5 is a functional diagram of a third embodiment of a wireless charging system of an unmanned aerial vehicle.

FIG. 6 is a flow chart of a working method of a receiving module in the wireless charging system of FIG. 5.

FIG. 7 is a functional diagram of a forth embodiment of a wireless charging system of an unmanned aerial vehicle.

FIG. 8 is a flow chart of a working method of a receiving module in the wireless charging system of FIG. 7.

FIG. 9 is a flow chart of a working method of a transmitting module in the wireless charging system of FIG. 7.

FIG. 10 is a functional diagram of a fifth embodiment of a wireless charging system of an unmanned aerial vehicle.

FIG. 11 is a flow chart of a working method of a receiving module in the wireless charging system of FIG. 10.

FIG. 12 is a flow chart of a working method of a transmitting module in the wireless charging system of FIG. 10.

FIG. 13 is a functional diagram of a sixth embodiment of a wireless charging system of an unmanned aerial vehicle.

FIG. 14 is a flow chart of a working method of a receiving module in the wireless charging system of FIG. 13.

FIG. 15 is a flow chart of a working method of a transmitting module in the wireless charging system of FIG. 13.

FIG. 16 is a flow chart of another working method of a receiving module in the wireless charging system of FIG. 13.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated to illustrate details and features better. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

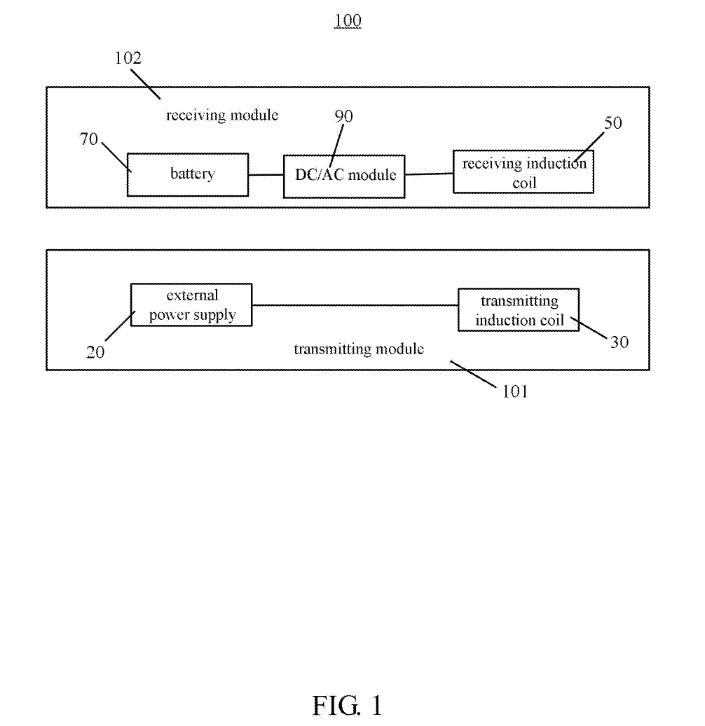

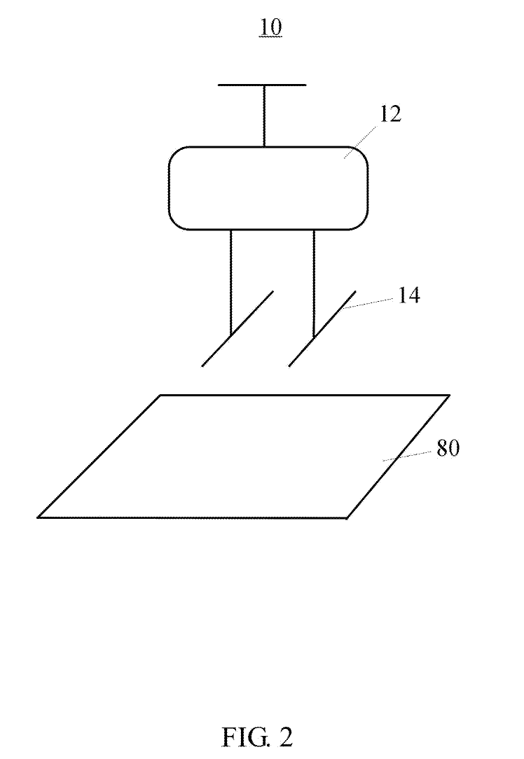

Referring to FIGS. 1-2, a wireless charging system 100 of an UAV 10 of the first embodiment is provided. The wireless charging system 100 includes an external power supply 20, at least one transmitting induction coil 30, at least one receiving induction coil 50, and a battery 70. The transmitting induction coil 30 is electrically connected to the external power supply 20. The receiving induction coil 50 is electrically connected to the battery 70. The transmitting induction coil 30 can be located in a parking mat 80. The receiving induction coil 50 can be located in a landing gear 14 of the UAV 10. The battery 70 can be located in a body 12 of the UAV 10. The UAV 10 can be parked on the parking mat 80 when the UAV 10 finishes flying. The material of the parking mat 80 can be insulating. The parking mat 80 can be located on the ground and move freely. The external power supply 20, the transmitting induction coil 30, and the parking mat 80 form a transmitting module 101. The receiving induction coil 50 and the battery 70 form a receiving module 102.

The transmitting induction coil 30 is configured to transmit an electric energy. The receiving induction coil 50 can receive the electric energy transmitted from the transmitting induction coil 30 by wireless electromagnetic induction. The electric energy received by the receiving induction coil 50 can be charged into the battery 70 and allow the UAV 10 to work.

The external power supply 20 can provide an alternating current or a pulse direct current. When the external power supply 20 provides the alternating current, the receiving module 102 should further include a DC/AC module 90 which is connected in series between the receiving induction coil 50 and the battery 70. The DC/AC module 90 can be used for converting the alternating current received by the receiving induction coil 50 into a direct current and outputting the direct current to the battery 70. When the external power supply 20 provides the pulse direct current, the DC/AC module 90 can be omitted.

Each of the transmitting induction coil 30 and the receiving induction coil 50 can be formed by coiling a conductive wire in the same plane or in spiral like a spring. The conductive wire of each loop can be in the same plane. The material of the conductive wire is not limited, such as metal. The electromagnetic inductive effect between the transmitting induction coil 30 and the receiving induction coil 50 is better when the conductive wire forming the transmitting induction coil 30 is coiled in the same plane and the conductive wire forming the receiving induction coil 50 is also coiled in the same plane.

Furthermore, the transmitting induction coil 30 can be located in a first housing which is located in the parking mat 80. The receiving induction coil 50 can be located in a second housing which is located in the landing gear 14 of the UAV 10. The material of the first housing is insulating for protecting the transmitting induction coil 30. The material of the second housing is insulating for protecting the receiving induction coil 50. The insulating materials forming the first housing and the second housing are not limited, such as plastic.

The number of the transmitting induction coil 30 and the receiving induction coil 50 is not limited. In the first embodiment, the number of the transmitting induction coil 30 is four, and the number of the receiving induction coil 50 is four; the landing fear 14 has four ends, and each end is provided with one receiving induction coil 50; and the four transmitting induction coils 30 are located in the parking mat 80 and corresponded to the four receiving induction coils 50 one by one.

The work process of the wireless charging system 100 of the UAV 10 is as follows. When the electric quantity of the battery 70 becomes low during use of the UAV 10, charging is required. The transmitting induction coil 30 located in the parking mat 80 generates an induced magnetic field due to connecting with the external power supply 20. When the UAV 10 descends to the parking mat 80, and the receiving induction coil 50 located in the landing gear 14 is close to the transmitting induction coil 30. The receiving induction coil 50 generates a corresponding induced current due to the presence of the induced magnetic field. The induced current charges the battery 70 located in the body 12 of the UAV 10. The induced current stored in the battery 70 can allow the UAV 10 to continue to work. Thus, the UAV 10 can be automatically charged. The transmitting induction coil 30 can be manually or automatically connected to the external power supply 20.

The distance between the transmitting induction coil 30 and the receiving induction coil 50 can be in a range from about 0 meter to about 1 meter during the use or operation of the wireless charging system 100 of the UAV 10. In one embodiment, the distance between the transmitting induction coil 30 and the receiving induction coil 50 is less than or equal to 5 centimeters.

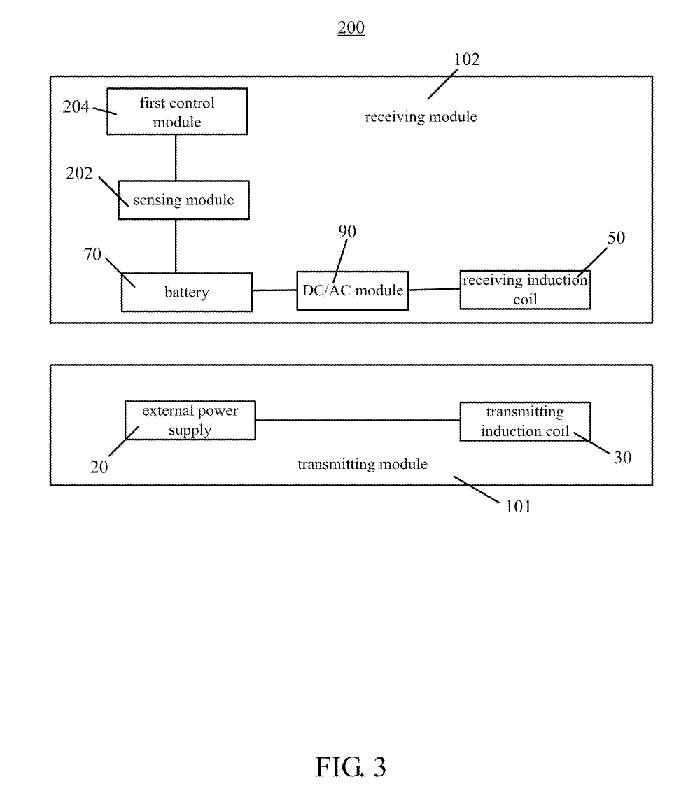

Referring to FIG. 3, a wireless charging system 200 of the UAV 10 of the second embodiment is shown where the receiving module 102 further includes a sensing module 202 and a first control module 204 electrically connected to the sensing module 202. The first control module 204 can be used to control the work of the receiving module 102 and control the taking-off and landing of the UAV 10. The first control module 204 can act as a central processing unit of the UAV 10. The sensing module 202 can be electrically connected to the battery 70. The sensing module 202 can be used for measuring the electric quantity of the battery 70, judging whether or not the electric quantity of the battery 70 is low, and judging whether or not the battery 70 needs to be charged. The sensing module 202 can be set a threshold value. When the electric quantity of the battery 70 is less than the threshold value, the battery 70 is judged to have a low electric quantity. For example, the threshold value is 5% of total electric quantity. When the electric quantity of the battery 70 is less than 5% of total electric quantity, the sensing module 202 judges that the electric quantity of the battery 70 is low and the battery 70 needs to be charged. When the electric quantity of the battery 70 is 100% of total electric quantity, the sensing module 202 judges that the electric quantity of the battery 70 is full and the battery 70 does not need to be charged. Furthermore, when the electric quantity of the battery 70 is equal to greater than 60% of total electric quantity, the sensing module 202 judges that the electric quantity of the battery 70 is high and the battery 70 does not need to be charged. In one embodiment, when the electric quantity of the battery 70 is equal to greater than 80% of total electric quantity, the sensing module 202 judges that the electric quantity of the battery 70 is high and the battery 70 does not need to be charged. In another embodiment, when the electric quantity of the battery 70 is equal to greater than 90% of total electric quantity, the sensing module 202 judges that the electric quantity of the battery 70 is high and the battery 70 does not need to be charged. In another embodiment, when the electric quantity of the battery 70 is equal to the total electric quantity, the sensing module 202 judges that the electric quantity of the battery 70 is full and the battery 70 does not need to be charged. That is, the electric quantity of the battery 70 is as high as one hundred percent of the total electric quantity. For another example, when the remaining electric quantity of the battery 70 can only allow the UAV 10 fly to the parking mat 80 from current position, the electric quantity of the battery 70 is considered low.

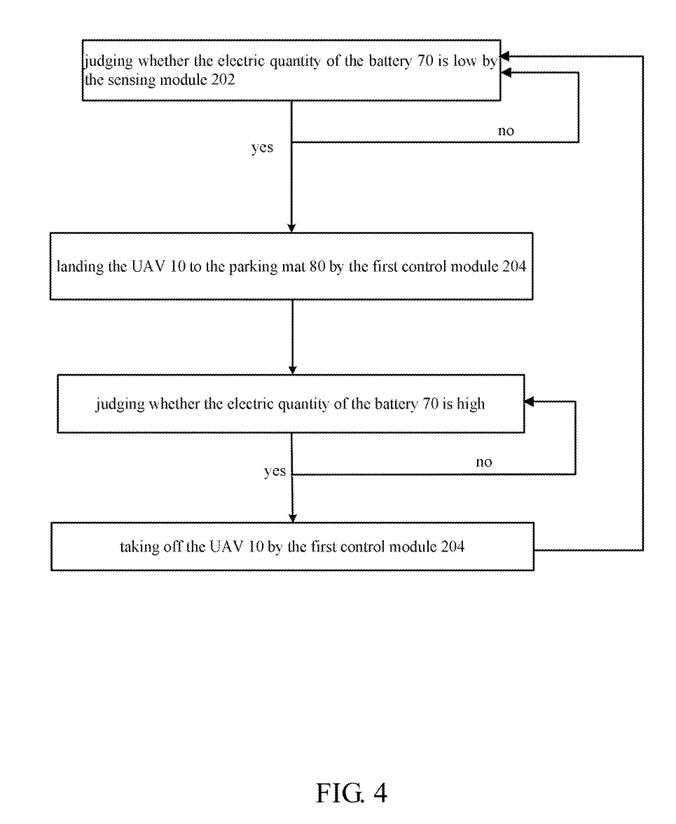

Referring to FIG. 4, a working method of the receiving module 102 in the wireless charging system 200 of the second embodiment includes following steps:

S21, judging whether the electric quantity of the battery 70 is low by the sensing module 202, if yes, go to S22, if no, repeating S21;

S22, landing the UAV 10 to the parking mat 80 by the first control module 204, go to S23;

S23, judging whether the electric quantity of the battery 70 is high, if yes, go to S24, if no, repeating S23; and

S24, taking off the UAV 10 by the first control module 204 and back to S21.

In the step S22, the receiving induction coil 50 located in the landing gear 14 is close to the transmitting induction coil 30. The receiving induction coil 50 generates the induced current due to the presence of the induced magnetic field, and the induced current is charged to the battery 70.

In the second embodiment, the transmitting induction coil 30 can be manually or automatically connected or disconnected to the external power supply 20, or always kept being connected to the external power supply 20.

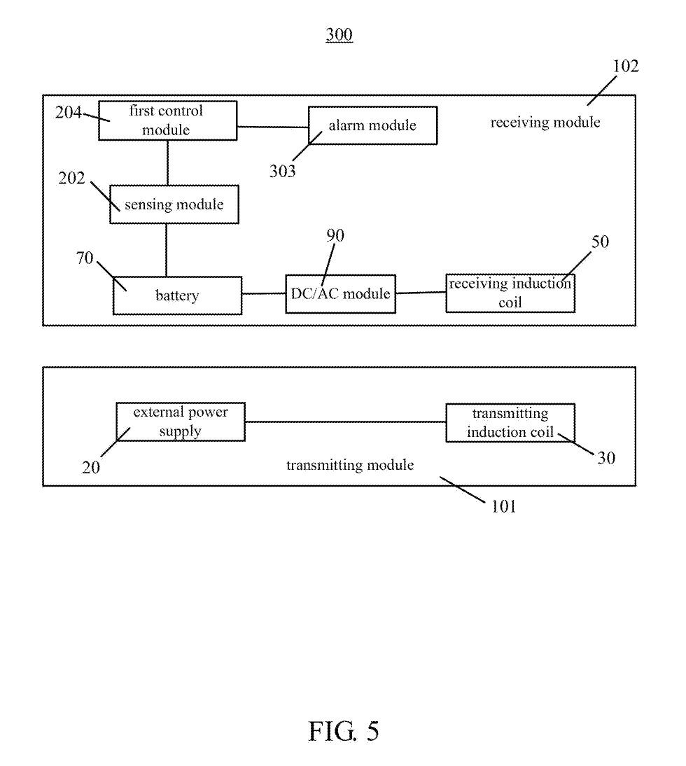

Referring to FIG. 5, a wireless charging system 300 of the UAV 10 of the third embodiment is provided. The wireless charging system 300 is similar to the wireless charging system 200 above except that the receiving module 102 of the wireless charging system 300 further includes an alarm module 303. The alarm module 303 is electrically connected to the first control module 204. The alarm module 303 can be used for issuing an alarm to remind the user of the UAV 10 that the UAV 10 needs to land or take off. The alarm can be a flash of a light, a sound, or image displayed on the remote controller. The alarm can be a message that is send to the user of the UAV 10.

When the sensing module 202 judges the electric quantity of the battery 70 is low, the sensing module 202 sends a low electric quantity information to the first control module 204, then the first control module 204 allows the alarm module 303 to issue the alarm. Thus, the user of the UAV 10 can know the UAV 10 needs to land to the parking mat 80 to be charged. When the sensing module 202 judges that electric quantity of the battery 70 is high, the sensing module 202 issues an electric quantity information to the first control module 204, then the first control module 204 allows the alarm module 303 to issue the alarm. Thus, the user of the UAV 10 can know that the UAV 10 is ready to take off.

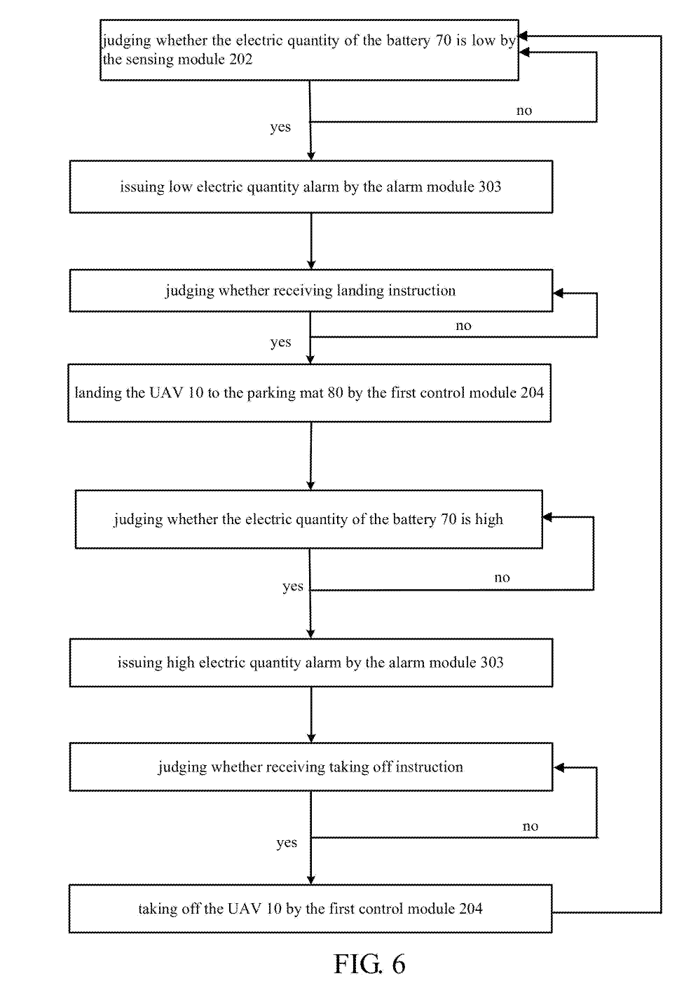

Referring to FIG. 6, a working method of the receiving module 102 in the wireless charging system 300 of the third embodiment includes following steps:

S31, judging whether the electric quantity of the battery 70 is low by the sensing module 202, if yes, go to S32, if no, repeating S31;

S32, issuing low electric quantity alarm by the alarm module 303, go to S33;

S33, judging whether receiving landing instruction, if yes, go to S34, if no, repeating S33;

S34, landing the UAV 10 to the parking mat 80 by the first control module 204, go to S35;

S35, judging whether the electric quantity of the battery 70 is high , if yes, go to S36, if no, repeating S35;

S36, issuing high electric quantity alarm by the alarm module 303, go to S37;

S37, judging whether receiving taking off instruction, if yes, go to S38, if no, repeating S37; and

S38, taking off the UAV 10 by the first control module 204 and back to S31.

In the third embodiment, the transmitting induction coil 30 can be manually or automatically connected or disconnected to the external power supply 20, or always kept being connected to the external power supply 20.

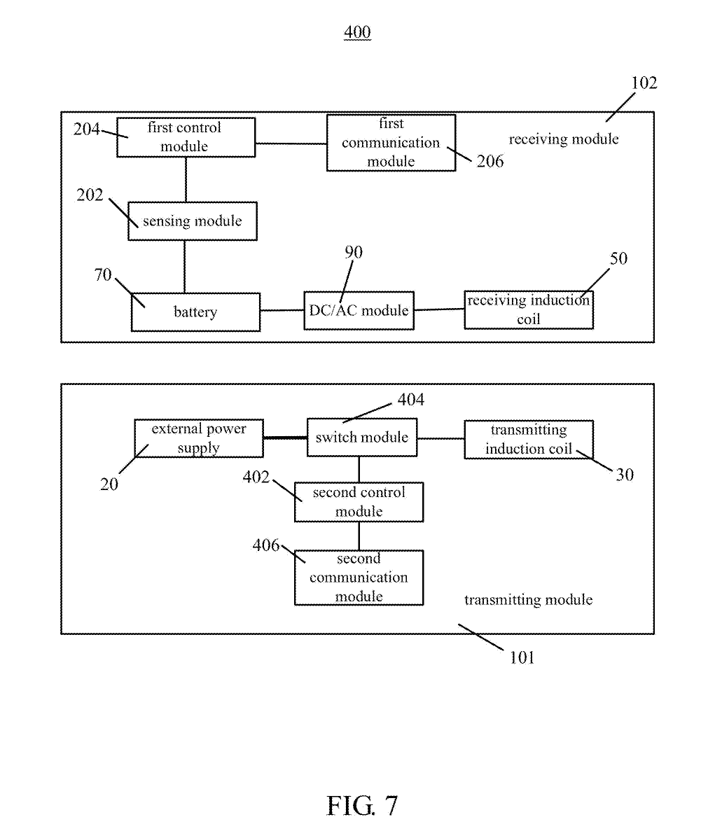

Referring to FIG. 7, a wireless charging system 400 of the UAV 10 of the forth embodiment is provided. The wireless charging system 400 is similar to the wireless charging system 200 above except that the receiving module 102 of the wireless charging system 400 further includes a first communication module 206; and the transmitting module 101 should further include a second control module 402, a second communication module 406, and a switch module 404. The first communication module 206 is electrically connected to the first control module 204. The second communication module 406 is electrically connected to the second control module 402. The switch module 404 is electrically connected to the second control module 402.

The second control module 402 can be used to control the work of the switch module 404 and the second communication module 406. The switch module 404 is electrically connected between the transmitting induction coil 30 and the external power supply 20. The switch module 404 can be used to control the connection or disconnection between the transmitting induction coil 30 and the external power supply 20. When the switch module 404 is turned on, the transmitting induction coil 30 is electrically connect to the external power supply 20. When the switch module 404 is turned off, the electrically connection between the transmitting induction coil 30 and the external power supply 20 is disconnected. The first communication module 206 and the second communication module 406 can be wireless communication modules, such as Bluetooth communication module, infrared communication module, radio frequency communication module. The first communication module 206 and the second communication module 406 can be wired communication module, such as USB communication module or the like.

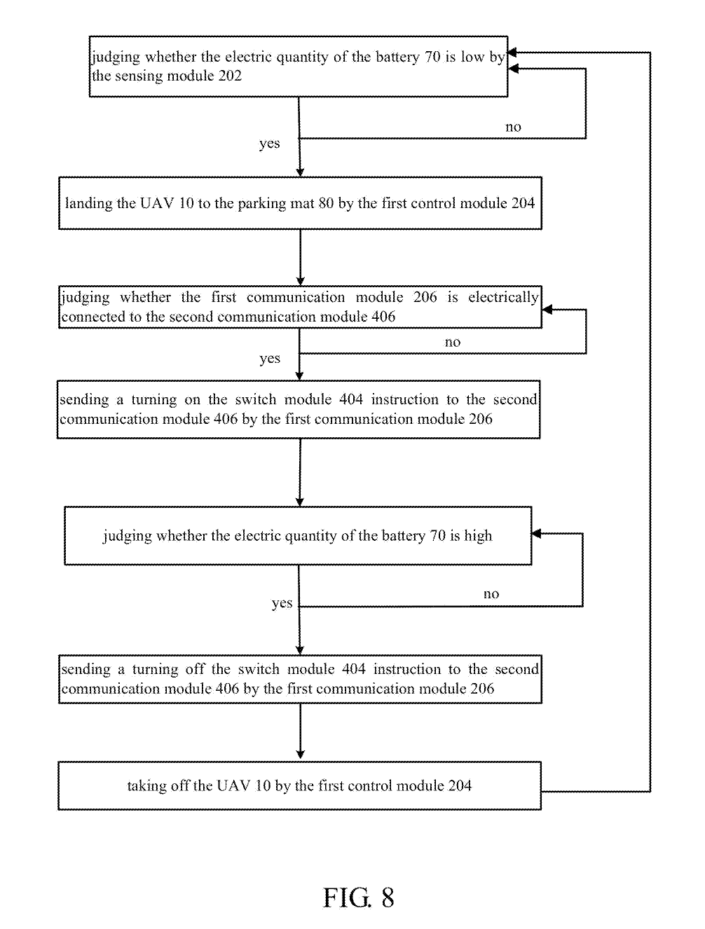

Referring to FIG. 8, a working method of the receiving module 102 in the wireless charging system 400 of the forth embodiment includes following steps:

S41, judging whether the electric quantity of the battery 70 is low by the sensing module 202, if yes, go to S42, if no, repeating S41;

S42, landing the UAV 10 to the parking mat 80 by the first control module 204, go to S43;

S43, judging whether the first communication module 206 is electrically connected to the second communication module 406, if yes, go to S44, if no, repeating S43;

S44, sending a turning on the switch module 404 instruction to the second communication module 406 by the first communication module 206, go to S45;

S45, judging whether the electric quantity of the battery 70 is high, if yes, go to S46, if no, repeating S45;

S46, sending a turning off the switch module 404 instruction to the second communication module 406 by the first communication module 206, go to S47; and

S47, taking off the UAV 10 by the first control module 204 and back to S41.

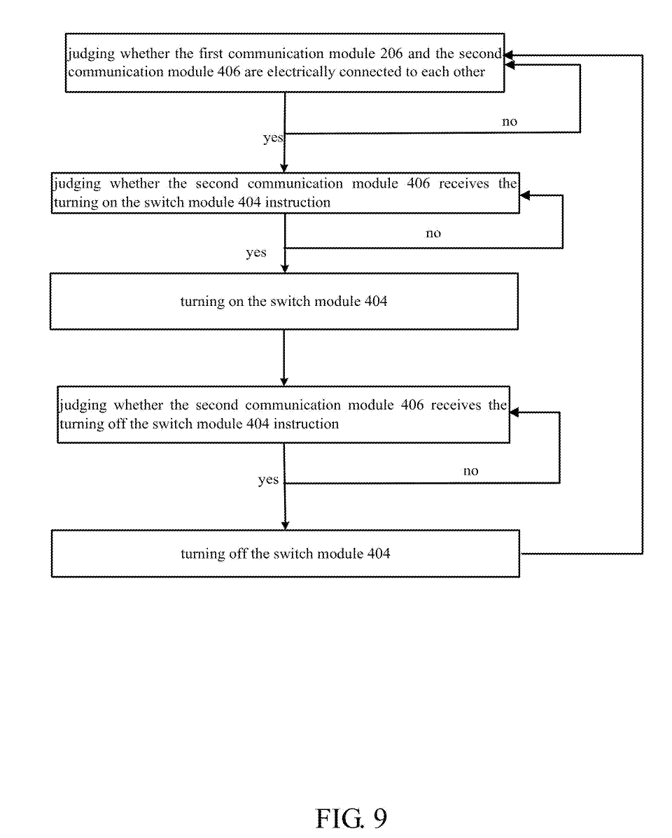

Referring to FIG. 9, a working method of the transmitting module 101 in the wireless charging system 400 of the forth embodiment includes following steps:

S41′, judging whether the first communication module 206 and the second communication module 406 are electrically connected to each other, if yes, go to S42′, if no, repeating S41′;

S42′, judging whether the second communication module 406 receives the turning on the switch module 404 instruction, if yes, go to S43′, if no, repeating S42′;

S43′, turning on the switch module 404, go to S44′; S44′, judging whether the second communication module 406 receives the turning off the switch module 404 instruction, if yes, go to S45′, if no, repeating S44′; and

S45′, turning off the switch module 404 and back to S41′.

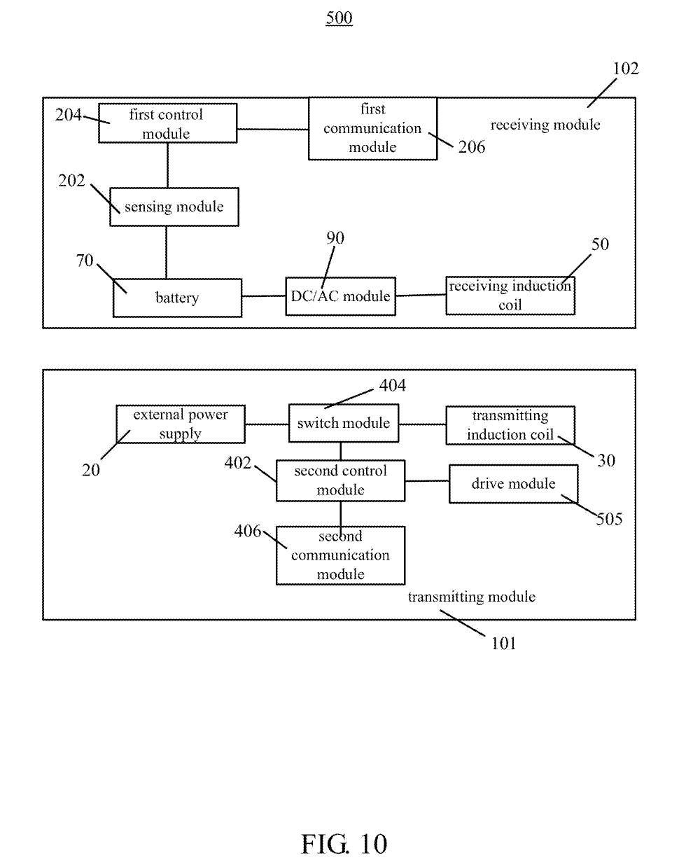

Referring to FIG. 10, a wireless charging system 500 of the UAV 10 of the fifth embodiment is provided. The wireless charging system 500 is similar to the wireless charging system 400 above except that the transmitting module 101 further includes a drive module 505. The drive module 505 is electrically connected to the second control module 402. The drive module 505 can include a drive wheel or the like. The drive module 505 can be used to allow the transmitting module 101 to form a mobile power supply. The transmitting module 101 can be driven to move toward the UAV 10 by the drive module 505. In this embodiment, the external power supply 20 can be a rechargeable battery that moves with the drive module 505, and the first communication module 206 and the second communication module 406 are remote wireless communication modules.

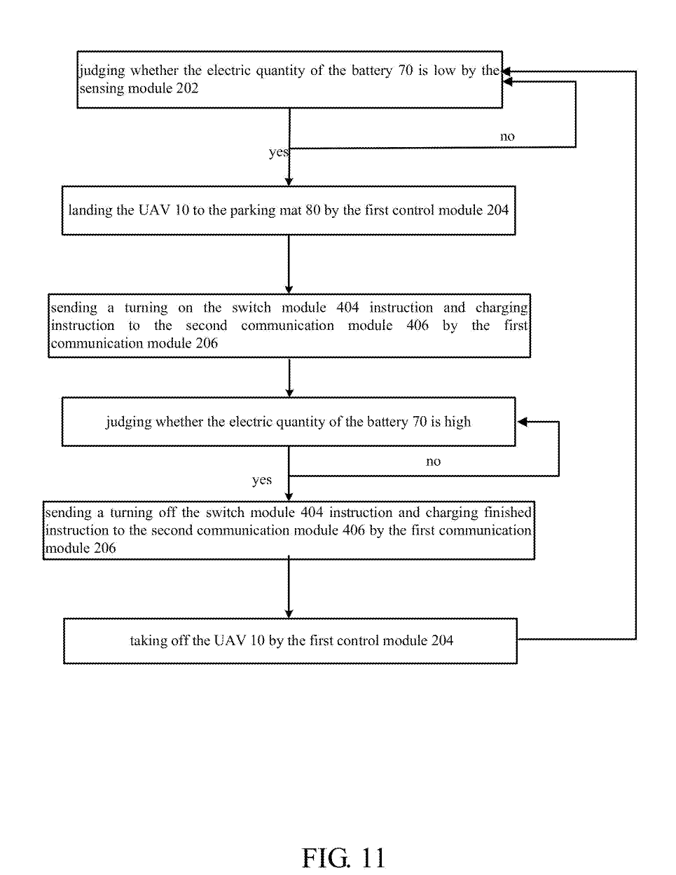

Referring to FIG. 11, a working method of the receiving module 102 in the wireless charging system 500 of the fifth embodiment includes following steps:

S51, judging whether the electric quantity of the battery 70 is low by the sensing module 202, if yes, go to S52, if no, repeating S51;

S52, landing the UAV 10 to the parking mat 80 by the first control module 204, go to S53;

S53, sending a turning on the switch module 404 instruction and charging instruction to the second communication module 406 by the first communication module 206, go to S54;

S54, judging whether the electric quantity of the battery 70 is high, if yes, go to S55, if no, repeating S54;

S55, sending a turning off the switch module 404 instruction and charging finished instruction to the second communication module 406 by the first communication module 206, go to S56; and

S56, taking off the UAV 10 by the first control module 204 and back to S51.

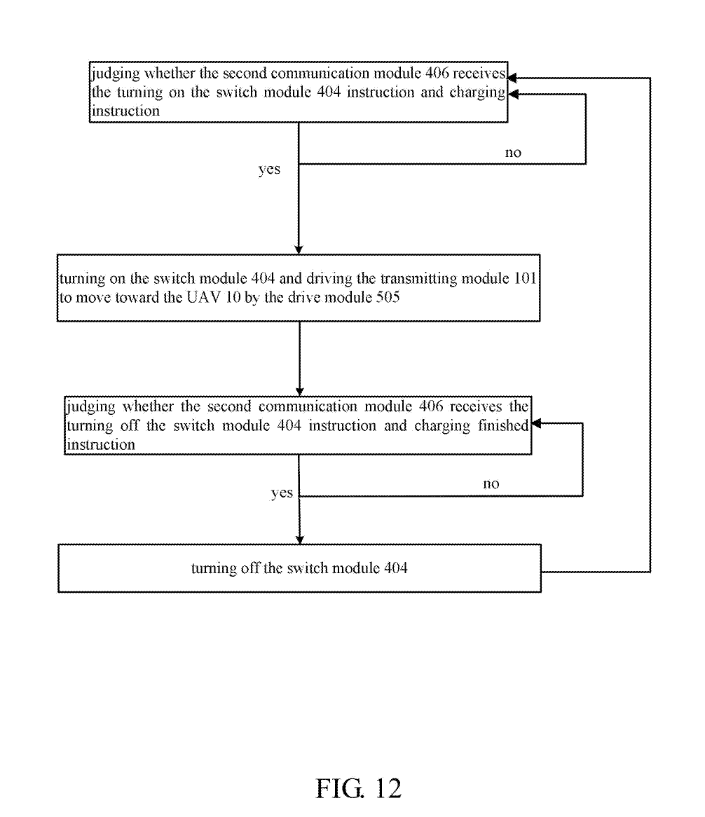

Referring to FIG. 12, a working method of the transmitting module 101 in the wireless charging system 500 of the fifth embodiment includes following steps:

S51′, judging whether the second communication module 406 receives the turning on the switch module 404 instruction and charging instruction, if yes, go to S52′, if no, repeating S51′;

S52′, turning on the switch module 404 and driving the transmitting module 101 to move toward the UAV 10 by the drive module 505, go to S53′;

S53′, judging whether the second communication module 406 receives the turning off the switch module 404 instruction and charging finished instruction, if yes, go to S54′, if no, repeating S53′; and

S54′, turning off the switch module 404 and back to S51′.

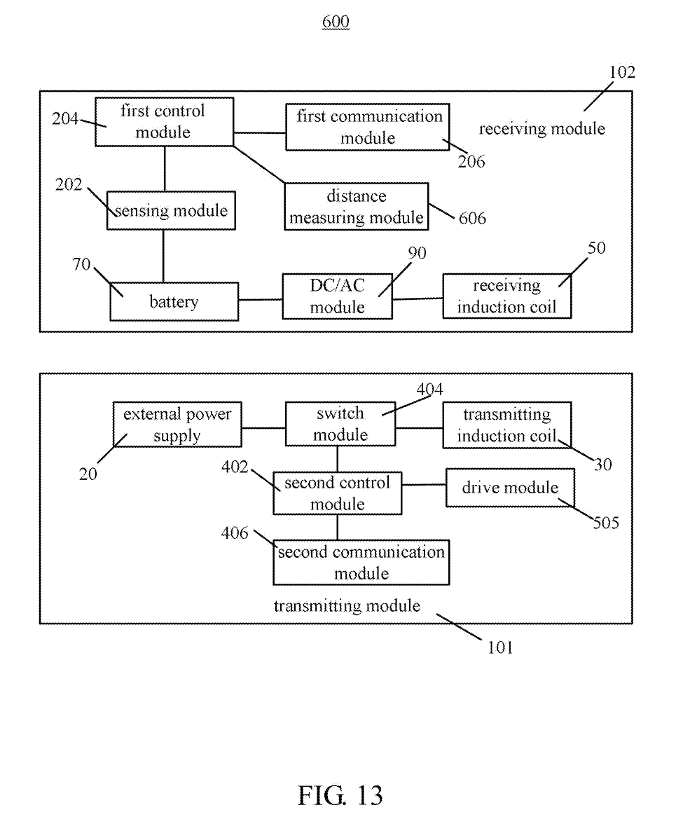

Referring to FIG. 13, a wireless charging system 600 of the UAV 10 of the fifth embodiment is provided. The wireless charging system 600 is similar to the wireless charging system 500 above except that the receiving module 102 further includes a distance measuring module 606. The distance measuring module 606 is used to measure the distance between the UAV 10 and the parking mat 80, and judge whether the electric quantity of the battery 70 allow UAV 10 to fly to the parking mat 80.

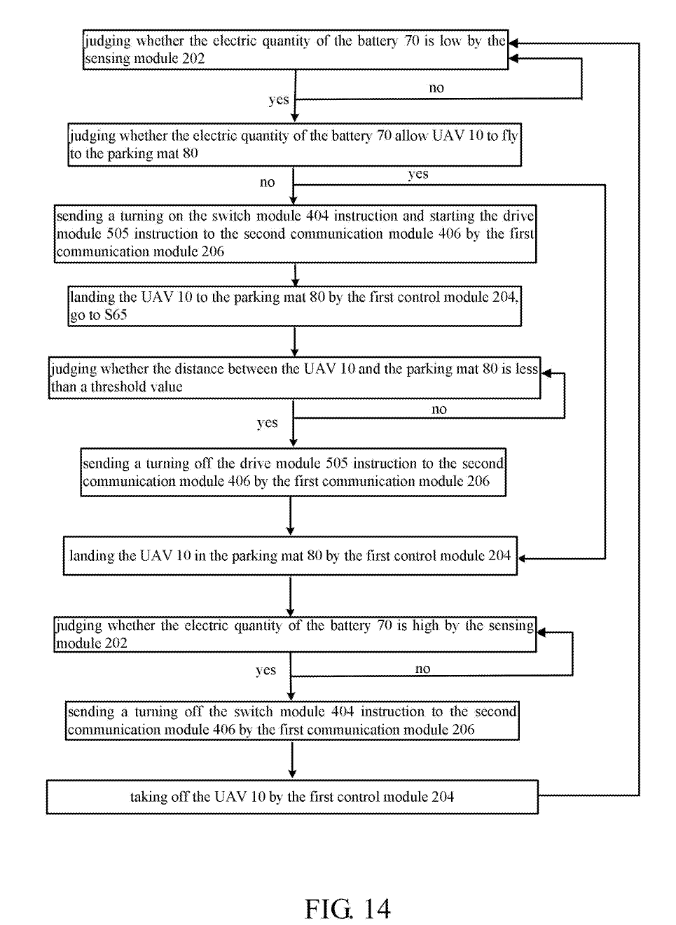

Referring to FIG. 14, a working method of the receiving module 102 in the wireless charging system 600 of the sixth embodiment includes following steps:

S61, judging whether the electric quantity of the battery 70 is low by the sensing module 202, if yes, go to S62, if no, repeating S61;

S62, judging whether the electric quantity of the battery 70 allow UAV 10 to fly to the parking mat 80, if no, go to S63; if yes, go to S67;

S63, sending a turning on the switch module 404 instruction and starting the drive module 505 instruction to the second communication module 406 by the first communication module 206, go to S64;

S64, landing the UAV 10 to the parking mat 80 by the first control module 204, go to S65;

S65, judging whether the distance between the UAV 10 and the parking mat 80 is less than a threshold value, if yes, go to S66, if no, repeating S65;

S66, sending a turning off the drive module 505 instruction to the second communication module 406 by the first communication module 206, go to S67;

S67, landing the UAV 10 in the parking mat 80 by the first control module 204, go to S68;

S68, judging whether the electric quantity of the battery 70 is high by the sensing module 202, if yes, go to S69, if no, repeating S68;

S69, sending a turning off the switch module 404 instruction to the second communication module 406 by the first communication module 206, go to S70; and

S70, taking off the UAV 10 by the first control module 204 and back to S61.

In the step S63, sending the turning on the switch module 404 instruction to the second communication module 406 by the first communication module 206 can also be executed in the step S66.

In the step S65, the selection of the threshold value is varied. In one embodiment, when the horizontal distance between the UAV 10 and the parking mat 80 is zero, the UAV 10 is vertically landed on the parking mat 80.

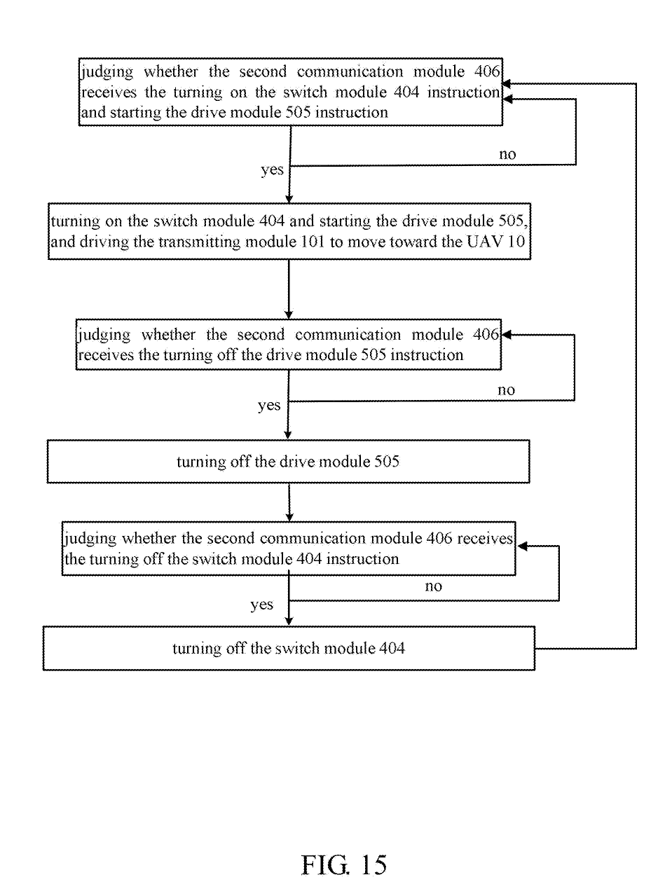

Referring to FIG. 15, a working method of the transmitting module 101 in the wireless charging system 600 of the sixth embodiment includes following steps: S61′, judging whether the second communication module 406 receives the turning on the switch module 404 instruction and starting the drive module 505 instruction, if yes, go to S62′, if no, repeating S61′;

S62′, turning on the switch module 404 and starting the drive module 505, and driving the transmitting module 101 to move toward the UAV 10, go to S63′;

S63′, judging whether the second communication module 406 receives the turning off the drive module 505 instruction, if yes, go to S64′, if no, repeating S63′;

S64′, turning off the drive module 505, go to S65′;

S65′, judging whether the second communication module 406 receives the turning off the switch module 404 instruction, if yes, go to S66′, if no, repeating S65′;

S66′, turning off the switch module 404 and back to S61′.

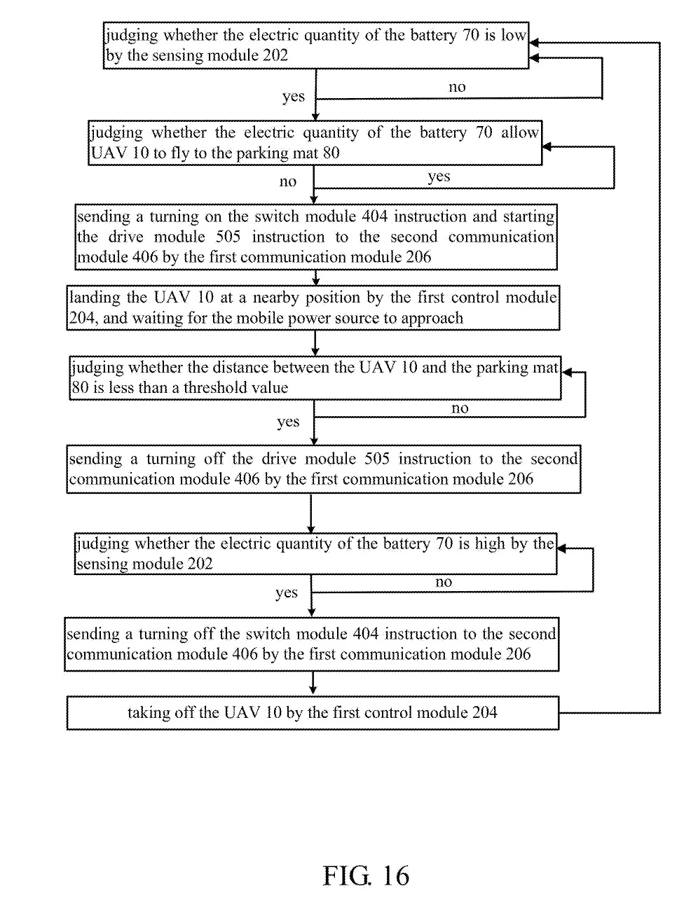

Furthermore, when the electric quantity of the battery 70 does not allow the UAV 10 to fly to the parking mat 80, the UAV 10 stop flying and the UAV 10 lands at nearby position. The mobile power source formed by the transmitting module 101 will move toward the UAV 10. FIG. 16 is a flow chart of the receiving module 102 in this case.

Referring to FIG. 16, another working method of the receiving module 102 in the wireless charging system 600 of the sixth embodiment includes following steps:

S601, judging whether the electric quantity of the battery 70 is low by the sensing module 202, if yes, go to S602, if no, repeating S601;

S602, judging whether the electric quantity of the battery 70 allow UAV 10 to fly to the parking mat 80, if no, go to S603; if yes, repeating S602;

S603, sending a turning on the switch module 404 instruction and starting the drive module 505 instruction to the second communication module 406 by the first communication module 206, go to S604;

S604, landing the UAV 10 at a nearby position by the first control module 204, and waiting for the mobile power source to approach, go to S605;

S605, judging whether the distance between the UAV 10 and the parking mat 80 is less than a threshold value, if yes, go to S606, if no, repeating S605;

S606, sending a turning off the drive module 505 instruction to the second communication module 406 by the first communication module 206, go to S607;

S607, judging whether the electric quantity of the battery 70 is high by the sensing module 202, if yes, go to S608, if no, repeating S607;

S608, sending a turning off the switch module 404 instruction to the second communication module 406 by the first communication module 206, go to S609; and

S609, taking off the UAV 10 by the first control module 204 and back to S601.

In the Step S603, sending the turning on the switch module 404 instruction to the second communication module 406 by the first communication module 206 can also be executed in the step S606.

When the electric quantity of the battery 70 does not allow the UAV 10 to fly to the parking mat 80, the UAV 10 lands at nearby position and waits for the transmitting module 101 to move toward the UAV 10. In this case, the working method of the transmitting module 101 is the same as the working method of the transmitting module 101 in FIG. 15.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Additionally, it is also to be understood that the above description and the claims drawn to a method may comprise some indication in reference to certain steps. However, the indication used is only to be viewed for identification purposes and not as a suggestion as to an order for the steps.

What is claimed is:

1. A wireless charging system of an unmanned aerial vehicle comprising:
a receiving module comprising a receiving induction coil, a battery, a sensing module electrically connected to the battery, a first control module electrically connected to the sensing module, and a first communication module electrically connected to the first control module; wherein the receiving induction coil is located in a landing gear of the unmanned aerial vehicle and electrically connected to the battery, and the receiving induction coil is used to generate an induced current and charge the battery; and the sensing module is used to judge an electric quantity of the battery, and the first control module is used to control taking-off and landing of the unmanned aerial vehicle; and
a transmitting module comprising an external power supply, a transmitting induction coil electrically connected to the external power supply, a second control module, a second communication module electrically connected to the second control module, a switch module electrically connected to the second control module, and a drive module electrically connected to the second control module; wherein the transmitting induction coil is located in a parking mat and is used to generate an induced magnetic field, the second control module is used to control the switch module and the second communication module, the switch module is electrically connected between the transmitting induction coil and the external power supply, and the drive module is used to allow the transmitting module to be mobile.

2. The wireless charging system of claim 1, wherein a working method of the receiving module comprising:
S51, judging whether the electric quantity of the battery is low by the sensing module, if yes, go to S52, if no, repeating S51;
S52, landing the unmanned aerial vehicle to the parking mat by the first control module, go to S53;
S53, sending an instruction for turning on the switch module instruction and charging instruction to the second communication module by the first communication module, go to S54;
S54, judging whether the electric quantity of the battery is high by the sensing module, if yes, go to S55, if no, repeating S54;
S55, sending an instruction for turning off the switch module instruction and charging finished instruction to the second communication module by the first communication module, go to S56; and
S56, taking off the unmanned aerial vehicle by the first control module and back to S51.

3. The wireless charging system of claim 2, wherein a working method of the transmitting module comprising:
S51′, judging whether the second communication module receives the turning on the switch module instruction and charging instruction, if yes, go to S52′, if no, repeating S51′;
S52′, turning on the switch module and driving the transmitting module to move toward the unmanned aerial vehicle, go to S53′;
S53′, judging whether the second communication module receives the turning off the switch module instruction and charging finished instruction, if yes, go to S54′, if no, repeating S53′; and
S54′, turning off the switch module and back to S51′.

4. The wireless charging system of claim 1, wherein the receiving module further comprises a distance measuring module; and the distance measuring module is used to measure a distance between the unmanned aerial vehicle and the parking mat, and judge whether the electric quantity of the battery allow the unmanned aerial vehicle to fly to the parking mat.

5. The wireless charging system of claim 4, wherein a working method of the receiving module comprising:
S61, judging whether the electric quantity of the battery is low by the sensing module, if yes, go to S62, if no, repeating S61;
S62, judging whether the electric quantity of the battery allow the unmanned aerial vehicle to fly to the parking mat, if no, go to S63; if yes, go to S67;
S63, sending a turning on the switch module instruction and a starting the drive module instruction to the second communication module by the first communication module, go to S64;
S64, landing the unmanned aerial vehicle to the parking mat by the first control module, go to S65;
S65, judging whether the distance between the unmanned aerial vehicle and the parking mat is less than a threshold value, if yes, go to S66, if no, repeating S65;
S66, sending a stopping the drive module instruction to the second communication module by the first communication module, go to S67;
S67, landing the unmanned aerial vehicle in the parking mat by the first control module, go to S68;
S68, judging whether the electric quantity of the battery is high by the sensing module, if yes, go to S69, if no, repeating S68;
S69, sending a turning off the switch module instruction to the second communication module by the first communication module, go to S70; and
S70, taking off the unmanned aerial vehicle by the first control module and back to S61.

6. The wireless charging system of claim 5, wherein a working method of the transmitting module comprising:
S61′, judging whether the second communication module receives the turning on the switch module instruction and the starting the drive module instruction, if yes, go to S62′, if no, repeating S61′;
S62′, turning on the switch module and starting the drive module, and driving the transmitting module to move toward the unmanned aerial vehicle, go to S63′;
S63′, judging whether the second communication module receives the stopping the drive module instruction, if yes, go to S64′, if no, repeating S63′;
S64′, stopping the drive module, go to S65′;
S65′, judging whether the second communication module receives the turning off the switch module instruction, if yes, go to S66′, if no, repeating S65′;
S66′, turning off the switch module and back to S61′.

7. The wireless charging system of claim 4, wherein a working method of the receiving module comprising:
S601, judging whether the electric quantity of the battery is low by the sensing module, if yes, go to S602, if no, repeating S601;
S602, judging whether the electric quantity of the battery allow the unmanned aerial vehicle to fly to the parking mat, if no, go to S603; if yes, repeating S602;
S603, sending a turning on the switch module instruction and a starting the drive module instruction to the second communication module by the first communication module, go to S604;
S604, landing the unmanned aerial vehicle at a nearby position by the first control module, and waiting for a mobile power source to approach, go to S605;
S605, judging whether the distance between the unmanned aerial vehicle and the parking mat is less than a threshold value, if yes, go to S606, if no, repeating S605;
S606, sending a stopping the drive module instruction to the second communication module by the first communication module, go to S607;
S607, judging whether the electric quantity of the battery is high by the sensing module, if yes, go to S608, if no, repeating S607;
S608, sending a turning off the switch module instruction to the second communication module by the first communication module, go to S609; and
S609, taking off the unmanned aerial vehicle by the first control module and back to S601.

8. The wireless charging system of claim 7, wherein in the S602, if the electric quantity of the battery allows the unmanned aerial vehicle to fly to the parking mat, the unmanned aerial vehicle is landed in the parking mat to be charged.

9. An unmanned aerial vehicle comprising:
a body comprising a landing gear; and
a wireless charging system comprising:
a transmitting module comprising an external power supply, a transmitting induction coil electrically connected to the external power supply, a second control module, a second communication module electrically connected to the second control module, a switch module electrically connected to the second control module, and a drive module electrically connected to the second control module; wherein the transmitting induction coil is located in a parking mat and is used to generates an induced magnetic field, the second control module is used to control the switch module and the second communication module, the switch module is electrically connected between the transmitting induction coil and the external power supply, and the drive module is used to allow the transmitting module to be mobile; and
a receiving module comprising a receiving induction coil, a battery, a sensing module electrically connected to the battery, a first control module electrically connected to the sensing module, and a first communication module electrically connected to the first control module; wherein the receiving induction coil is located in the landing gear and electrically connected to the battery, and the receiving induction coil is used to generate an induced current and charge the battery; and the sensing module is used to judge an electric quantity of the battery, and the first control module is used to control taking-off and landing of the unmanned aerial vehicle.

10. The wireless charging system of claim 9, wherein a working method of the receiving module comprising:
S51, judging whether the electric quantity of the battery is low by the sensing module, if yes, go to S52, if no, repeating S51;
S52, landing the unmanned aerial vehicle to the parking mat by the first control module, go to S53;
S53, sending an instruction for turning on the switch module instruction and charging instruction to the second communication module by the first communication module, go to S54;
S54, judging whether the electric quantity of the battery is high by the sensing module, if yes, go to S55, if no, repeating S54;
S55, sending an instruction for turning off the switch module instruction and charging finished instruction to the second communication module by the first communication module, go to S56; and
S56, taking off the unmanned aerial vehicle by the first control module and back to S51.

11. The wireless charging system of claim 10, wherein a working method of the transmitting module comprising:
S51′, judging whether the second communication module receives the turning on the switch module instruction and charging instruction, if yes, go to S52′, if no, repeating S51′;
S52′, turning on the switch module and driving the transmitting module to move toward the unmanned aerial vehicle, go to S53′;
S53′, judging whether the second communication module receives the turning off the switch module instruction and charging finished instruction, if yes, go to S54′, if no, repeating S53′; and
S54′, turning off the switch module and back to S51′.

12. The wireless charging system of claim 9, wherein the receiving module further comprises a distance measuring module; and the distance measuring module is used to measure a distance between the unmanned aerial vehicle and the parking mat, and judge whether the electric quantity of the battery allow the unmanned aerial vehicle to fly to the parking mat.

13. The wireless charging system of claim 12, wherein a working method of the receiving module comprising:
S61, judging whether the electric quantity of the battery is low by the sensing module, if yes, go to S62, if no, repeating S61;
S62, judging whether the electric quantity of the battery allow the unmanned aerial vehicle to fly to the parking mat, if no, go to S63; if yes, go to S67;
S63, sending a turning on the switch module instruction and a starting the drive module instruction to the second communication module by the first communication module, go to S64;
S64, landing the unmanned aerial vehicle to the parking mat by the first control module, go to S65;
S65, judging whether the distance between the unmanned aerial vehicle and the parking mat is less than a threshold value, if yes, go to S66, if no, repeating S65;
S66, sending a stopping the drive module instruction to the second communication module by the first communication module, go to S67;
S67, landing the unmanned aerial vehicle in the parking mat by the first control module, go to S68;
S68, judging whether the electric quantity of the battery is high by the sensing module, if yes, go to S69, if no, repeating S68;
S69, sending a turning off the switch module instruction to the second communication module by the first communication module, go to S70; and
S70, taking off the unmanned aerial vehicle by the first control module and back to S61.

14. The wireless charging system of claim 13, wherein a working method of the transmitting module comprising:
S61′, judging whether the second communication module receives the turning on the switch module instruction and the starting the drive module instruction, if yes, go to S62′, if no, repeating S61′;
S62′, turning on the switch module and starting the drive module, and driving the transmitting module to move toward the unmanned aerial vehicle, go to S63′;
S63′, judging whether the second communication module receives the stopping the drive module instruction, if yes, go to S64′, if no, repeating S63′;
S64′, stopping the drive module, go to S65′;
S65′, judging whether the second communication module receives the turning off the switch module instruction, if yes, go to S66′, if no, repeating S65′;
S66′, turning off the switch module and back to S61′.

15. The wireless charging system of claim 12, wherein a working method of the receiving module comprising:
S601, judging whether the electric quantity of the battery is low by the sensing module, if yes, go to S602, if no, repeating S601;
S602, judging whether the electric quantity of the battery allow the unmanned aerial vehicle to fly to the parking mat, if no, go to S603; if yes, repeating S602;
S603, sending a turning on the switch module instruction and a starting the drive module instruction to the second communication module by the first communication module, go to S604;
S604, landing the unmanned aerial vehicle at a nearby position by the first control module, and waiting for a mobile power source to approach, go to S605;
S605, judging whether the distance between the unmanned aerial vehicle and the parking mat is less than a threshold value, if yes, go to S606, if no, repeating S605;
S606, sending a stopping the drive module instruction to the second communication module by the first communication module, go to S607;
S607, judging whether the electric quantity of the battery is high by the sensing module, if yes, go to S608, if no, repeating S607;
S608, sending a turning off the switch module instruction to the second communication module by the first communication module, go to S609; and
S609, taking off the unmanned aerial vehicle by the first control module and back to S601.
